(19) United States
(12) Patent Application Publication
(10) Pub. No.: US 2025/0305998 A1
(43) Pub. Date: Oct. 2, 2025

(54) COMPACT THERMAL CONDUCTIVITY HOUSING FOR GAS CHROMATOGRAPH

(71) Applicant: Rosemount Inc., Shakopee, MN (US)

(72) Inventor: Edward ZHANG, Cypress, TX (US)

(21) Appl. No.: 18/619,768

(22) Filed: Mar. 28, 2024

(51) Int. Cl. G01N 30/62; B01D 53/02; G01N 30/02; G01N 30/30; G01N 30/38

(52) U.S. Cl. CPC G01N 30/62; B01D 53/025; G01N 30/30; G01N 30/38; G01N 2030/025; G01N 2030/3084

(57) ABSTRACT

A thermal conductivity detector for a gas chromatograph is provided. The thermal conductivity detector includes a circular thermal conductivity detector body having a sidewall and a top surface. A plurality of gas flow paths is formed in the circular thermal conductivity body. Each gas flow path includes a gas inlet disposed on the sidewall and a gas outlet disposed on the sidewall. The gas inlet and the gas outlet extend inwardly from the sidewall. Each gas flow path is in fluidic communication with a thermistor mounting hole, the thermistor mounting hole extending from the top surface of the thermal conductivity detector body. A process gas chromatograph using the thermal conductivity detector is also provided.

### BACKGROUND

Gas chromatography is the separation of a mixture of chemical compounds due to their migration rates through a chromatographic column. This separates the compounds based on differences in boiling point, polarity, or molecular size. The separated compounds then flow across a suitable detector that determines the concentration of each compound represented in the overall sample. Knowing the concentration of the individual compounds makes it possible to calculate certain physical properties such as BTU or specific gravity using industry-standard equations.

In operation, a sample is often injected into a chromatographic column filled with a packing material. Typically, the packing material is referred to as a “stationary phase” as it remains fixed within the column. A supply of inert carrier gas is then provided to the column in order to force the injected sample through the stationary phase. The inert gas is referred to as the “mobile phase” since it transits the column.

As the mobile phase pushes the sample through the column, various forces cause the constituents of the sample to separate. For example, heavier components move more slowly through the column relative to the lighter components. The separated components, in turn, exit the column in a process called elution. The resulting components are then fed into a detector that responds to some physical trait of the eluting components.

One type of detector, a thermal conductivity detector (TCD), is used to analyze the components of a mixture. It works by measuring the thermal conductivity of the gas eluting from the column, which is a bulk property of the gas that depends on the identity and concentration of its components.

Known thermal conductivity detectors generally include two identical chambers. One chamber receives the carrier gas flowing from the GC column, while the other chamber receives a reference gas of constant composition. Identical chambers are maintained at a constant temperature. As the gas flows through the chambers, it conducts heat away from the temperature sensor, typically a thermistor, located in each chamber. If the thermal conductivity of the gas in the sample chamber is different from the reference gas, the rate of heat loss in that chamber will change. This change is detected by a difference between the two temperature sensor signals.

### SUMMARY

A thermal conductivity detector for a gas chromatograph is provided. The thermal conductivity detector includes a circular thermal conductivity detector body having a sidewall and a top surface. A plurality of gas flow paths is formed in the circular thermal conductivity body. Each gas flow path includes a gas inlet disposed on the sidewall and a gas outlet disposed on the sidewall. The gas inlet and the gas outlet extend inwardly from the sidewall. Each gas flow path is in fluidic communication with a thermistor mounting hole, the thermistor mounting hole extending from the top surface of the thermal conductivity detector body. A process gas chromatograph using the thermal conductivity detector is also provided.

### BRIEF DESCRIPTION OF THE DRAWINGS

FIG. 1 is a diagrammatic view of a process gas chromatograph with which embodiments of the present invention may be used.

FIG. 2 is a diagrammatic system view of a gas chromatograph with which embodiments of the present invention are particularly useful.

FIG. 3 is a perspective view of a temperature sensor of the type generally used in thermal conductivity detectors.

FIG. 4A is a diagrammatic perspective view of a thermal conductivity detector block in accordance with the prior art.

FIG. 4B is a diagrammatic perspective cutaway view of the thermal conductivity detector block in accordance with the prior art.

FIG. 4C is a diagrammatic perspective view of a thermal conductivity detector in accordance with the prior art.

FIG. 5A is a diagrammatic perspective view of a thermal conductivity detector body in accordance with an embodiment of the present invention.

FIG. 5B is a diagrammatic top cross-sectional view of a thermal conductivity detector body in accordance with an embodiment of the present invention.

FIG. 5C is a diagrammatic perspective cutaway view of a thermal conductivity detector body in accordance with an embodiment of the present invention.

FIG. 6 is a diagrammatic perspective view of a thermal conductivity detector in accordance with an embodiment of the present invention.

### DETAILED DESCRIPTION OF ILLUSTRATIVE EMBODIMENTS

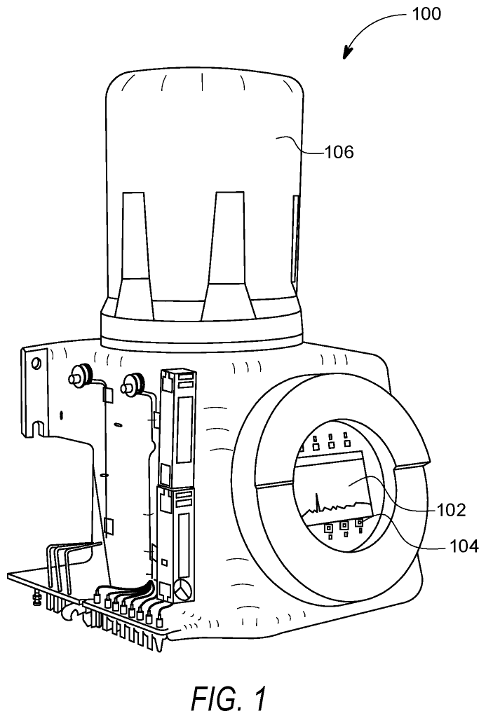

FIG. 1 is a diagrammatic view of a process gas chromatograph with which embodiments of the present invention may be used. While FIG. 1 illustrates a model 700XA gas chromatograph 100, available from Rosemount Inc. (Emerson Automation Solutions), methods and embodiments provided herein may be utilized with other exemplary gas analyzers. This can include model 1500XA process gas chromatographs and model 470XA natural gas chromatographs, both available from Rosemount Inc., among a variety of other types and models of gas chromatographs. Additionally, it is contemplated that a wide variety of other devices, beyond gas chromatographs, may be utilized with embodiments of the present invention. As shown in FIG. 1, process gas chromatograph 100 includes a user interface 102 having a display and one or more user input mechanisms 104. Additionally, process gas chromatograph 100 includes a temperature-controlled oven 106. Components within oven 106 can be kept at very-precisely controlled temperatures in order to facilitate the analytical process. In a process gas chromatograph, space within the temperature-controlled oven is at a premium. Any component that needs to be in the temperature-controlled oven should be as small as possible and the components should be packed as closely together as feasible.

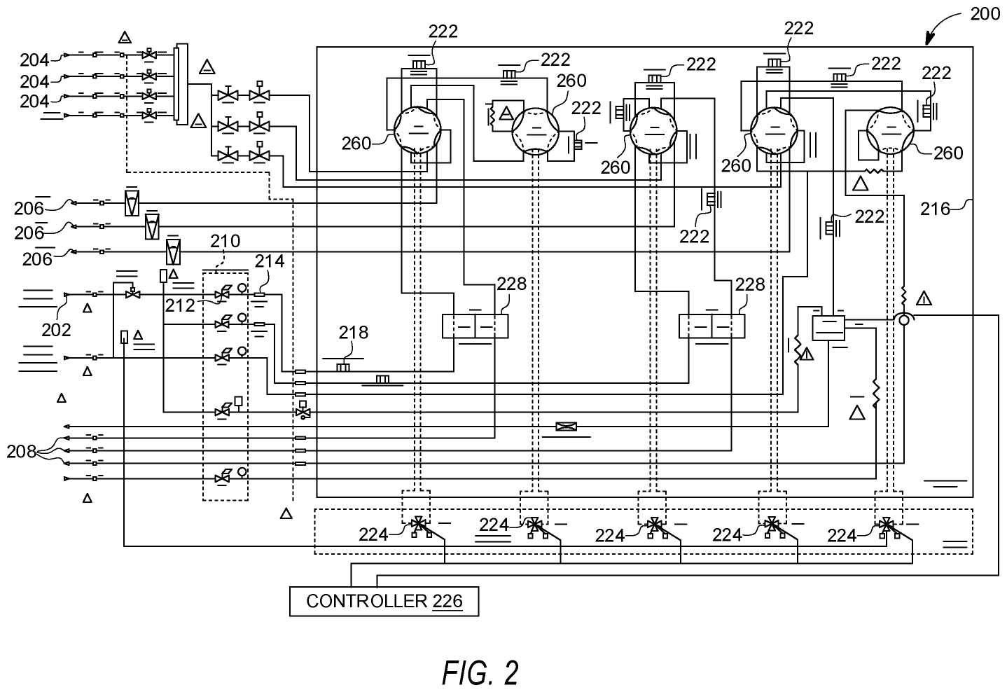

FIG. 2 is a diagrammatic system view of a gas chromatograph in accordance with an embodiment of the present invention. While one example of a gas chromatograph 200 will now be provided, it is to be understood that gas chromatograph 200 can take a wide variety of other forms and configurations. For example, it is to be understood that gas chromatograph 200 may have other configurations for columns, valves, detectors, et cetera. However, in this example, gas chromatograph 200 illustratively includes a carrier gas inlet 202, a sample inlet 204, a sample vent outlet 206, and a measure vent outlet 208. In operation, carrier gas is provided to flow panel 210 where it passes through a regulator 212 and dryer 214 before entering temperature-controlled analyzer oven 216 and passing through carrier gas pre-heat coils 218.

During measurement, sample gas enters chromatograph 200 via sample inlet 204 and passes into analyzer oven 216. Both sample gas (during measurement), or calibration gas (during calibration), and carrier gas eventually enter a plurality of pneumatically-controlled multi-port selector valves 260 in order to selectively flow various volumes of a sample and/or carrier gas through various chromatographic columns 222 in accordance with known gas chromatography techniques. Each of the pneumatically-controlled multi-port selector valves 260 is fluidically coupled to a respective solenoid valve 224 that receives its control signal from controller 226. Additionally, controller 226 may be coupled to one or more temperature sensors within oven 216 as well as one or more heaters thermally coupled to oven 216 in order to provide temperature control for oven 216. However, it is also contemplated that a thermal control system separate from controller 226 can also be used.

Additionally, as shown in FIG. 2, each pneumatically-controlled multi-port selector valve 260 has a pair of states. In the first state, the fluidic connections of each valve 260 are shown in solid lines. The fluid connections of each valve 260 in the second state are shown in phantom. Controller 226 is operably coupled to detector 228 which is a thermal conductivity detector which will be described in greater detail below. Thus, controller 226 is able to fully control flow through gas chromatograph 200 by virtue of controlling solenoid valves 224. Additionally, controller 226 is able to determine the response of detector 228 to detect, or otherwise characterize, various species in the sample gas. Controller 226 may characterize, calculate and identify peaks in the chromatogram. In this way, controller 226 is able to selectively introduce the sample into a chromatographic column for a selected amount of time, reverse the flow of gas through the chromatographic column, and direct the reversed flow through the detector to observe and/or record the detector response over time. This provides chromatographic analysis relative to the sample.

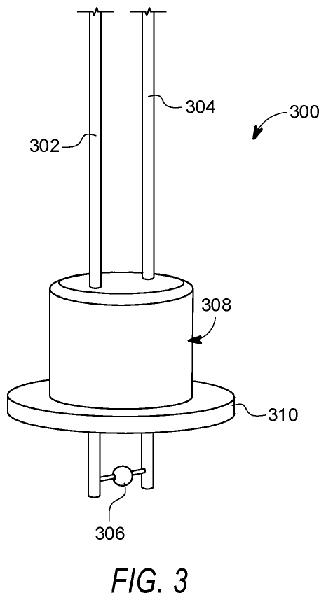

FIG. 3 is a perspective view of a temperature sensor of the type generally used in thermal conductivity detectors. Thermistor 300 generally includes a pair of leads 302, 304 that are electrically coupled to thermistor element 306. Thermistor element can be formed in any suitable manner. Thermistor element 306 is typically made from semiconductor materials, such as those used in computer chips. As the temperature changes, the way these materials conduct electricity changes as well. There are two main types of thermistors: Negative Temperature Coefficient (NTC) thermistors and Positive Temperature Coefficient (PTC) thermistors. These different types refer to the way in which the resistance changes as a function of temperature. As shown, leads 302, 304 pass through body 308 which is generally cylindrically shaped having a flange 310 on a lower surface thereof. Leads 302, 304 pass through and extend from flange 310 and mechanically suspend thermistor element 306 therebetween.

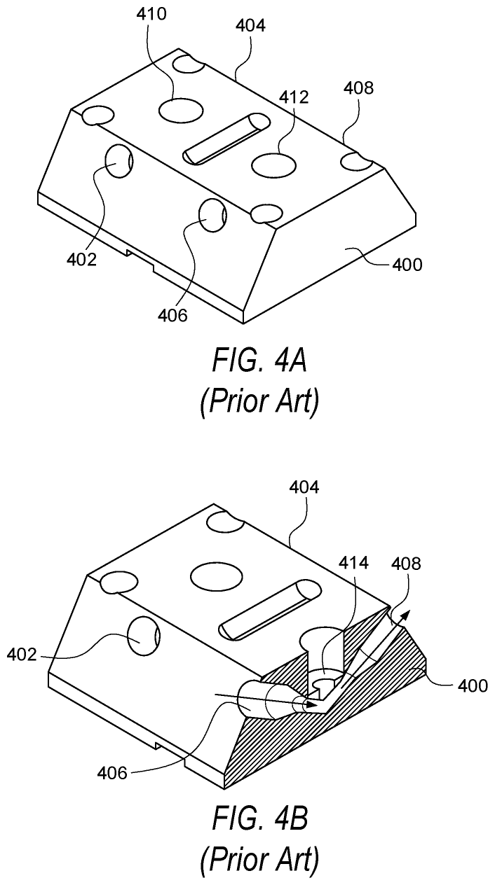

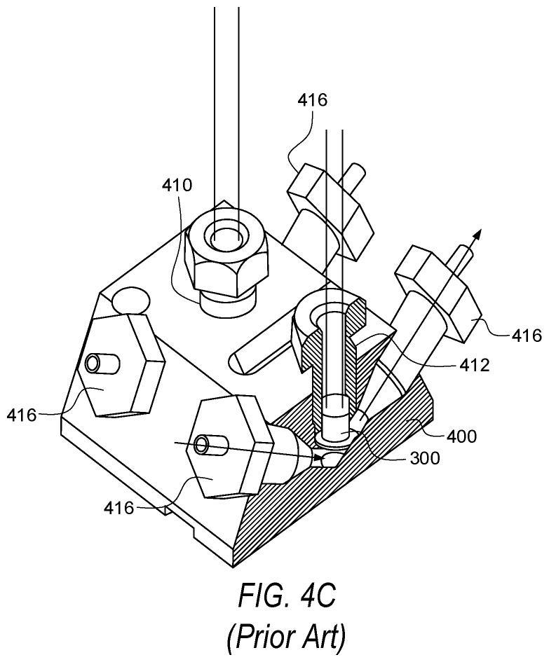

FIG. 4A is a diagrammatic perspective view of a thermal conductivity sensor block in accordance with the prior art. FIG. 4A shows a common commercially-available thermal conductivity sensor housing design. A complete thermal conductivity sensor block 400 includes two sets of flow paths “I” to “O”. One set, 402, 404, is for reference gas and the other set 406, 408, is for the measurement. Block 400 generally includes a mounting hole for each thermistor. As shown, mounting hole 410 is disposed to mount a thermistor for the reference set 402, 404, while hole 412 is disposed to mount a thermistor for the measurement set 406, 408.

FIG. 4B is a diagrammatic perspective cutaway view of the thermal conductivity sensor block in accordance with the prior art. FIG. 4B shows a cutaway that illustrates the fluidic communication between inlet port 406 of the measurement set and outlet port 408. This flow passageway is termed the measurement flow channel. The reference flow channel (i.e., between ports 402, 404), not shown, is generally identical to illustrated measurement channel.

FIG. 4C is a diagrammatic perspective view of a thermal conductivity sensor in accordance with the prior art. FIG. 4C shows block 400 with gas fittings 416 mounted to respective ports, and thermistors, such as thermistor 300, mounted to each of holes 410, 412. If a gas chromatograph requires more than one thermal conductivity detector, block 400 is typically cloned such that multiple blocks 400 are provided for the multiple thermal conductivity sensors. The thermal conductivity detector is a component that must be housed within the temperature-controlled oven of the gas chromatograph. As such, when two thermal conductivity detectors are required, such detectors must be housed within the oven and typically occupy a significant amount of the valuable space no matter how they are arranged. Since each thermal conductivity detector has its own block/housing, it is almost impossible to use the technique of common reference to increase the number of thermal conductivity detectors to minimize the space used within the oven of the gas chromatograph.

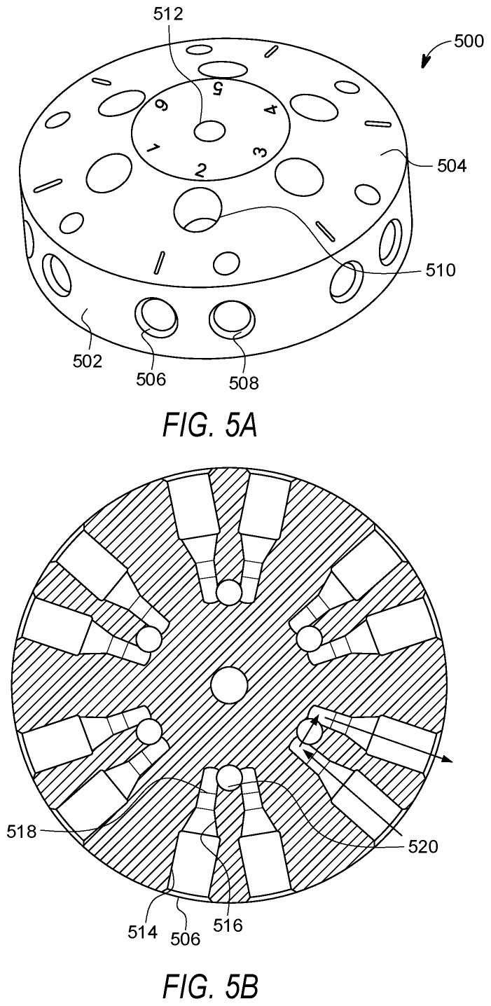

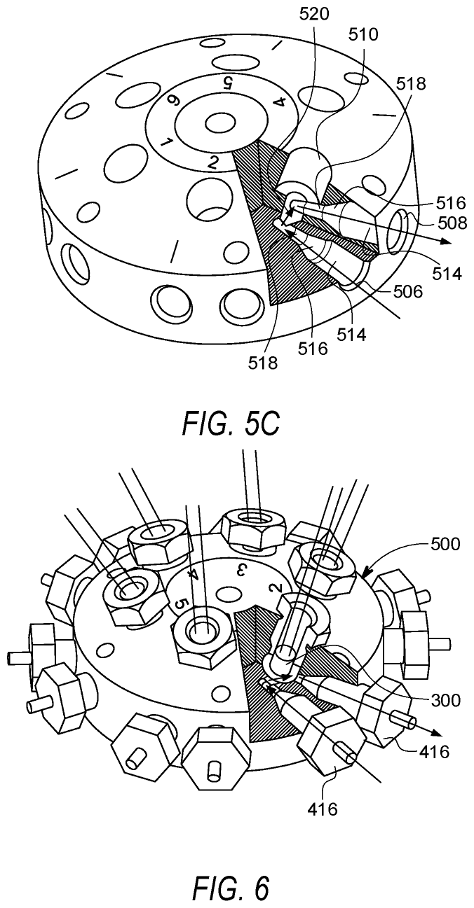

FIG. 5A is a diagrammatic perspective view of a thermal conductivity sensor body in accordance with an embodiment of the present invention. Embodiments of the present invention generally provide a thermal conductivity detector for a gas chromatograph that arranges gas flow paths radially on a cylindrical housing thereby providing a very compact design where multiple thermistors can be installed to form more than one set of thermal conductivity detectors. Due to the compact nature of the design, the temperature is the same for all of the thermistors. If using a common reference of a thermistor, more thermal conductivity detectors can be formed. Embodiments described herein not only save cost but also for multiple thermal conductivity detectors is using a common reference of the thermistor and improve measurement and accuracy.

FIG. 5A shows thermal conductivity body 500 having six distinct flow paths (labeled 1-6), where each flow path has an inlet labeled “I” and an outlet labeled “O” on a cylindrical sidewall 502 of body 500. Additionally, body 500 includes thermistor mounting holes on a top surface 504 of body 500. As can be seen, each respective flow path includes an inlet, such as port 506, an outlet, such as port 508, and a thermistor mounting hole, such as hole 510. Additionally, body 500 includes a central aperture 512 for a temperature sensor such as an RTD or a thermocouple. Mounting holes (not shown in the illustrations) can be inserted in open space to secure body 500 within the oven of the gas chromatograph.

FIG. 5B is a diagrammatic top cross-sectional view of a thermal conductivity sensor body in accordance with an embodiment of the present invention. FIG. 5B shows how the six distinct flow paths are arranged. In the illustrated embodiment, each inlet and outlet port is created along a radius, such that if the port had a depth of a radius, the port would intersect the center of body 500. Each port is spaced apart from the other ports, but each inlet and outlet pair are generally spaced closer together than the spacing between pairs. Each port, such as port 506 includes an internally threaded cylindrical portion 514 that is connected to a respective taper portion 516. Each taper portion 516 is connected to a distal cylindrical portion 518 that is in fluidic communication with bore 520, which sits below a thermistor mounting hole 510. The taper portion 516 helps create a leak-proof connection of the compressed fitting.

FIG. 5C is a diagrammatic perspective cutaway view of a thermal conductivity sensor body in accordance with an embodiment of the present invention. As shown in FIG. 5C, each of ports 506 and 508 has similar internal geometry and is fluidically coupled with the other by intersection with bore 520 (also shown in FIG. 5B). Thus, gas flowing into an inlet reaches distal portion 518 then encounters a thermistor element in bore 520.

FIG. 6 is a diagrammatic perspective view of a thermal conductivity detector in accordance with an embodiment of the present invention. FIG. 6 shows body 500 with multiple gas fittings 416 mounted to each port and multiple thermistors, such as thermistor 300, mounted to each thermistor mounting hole 510. As can be seen, a very compact thermal conductivity detector is provided. Additionally, the illustrated detector has six distinct flow paths and thermistors. However, those skilled in the art will recognize that embodiments of the present invention can be practiced with fewer than six distinct flow paths, as well as with more than six distinct flow paths.

If using a reference for each set of thermal conductivity detectors, the embodiment described with respect to FIGS. 5A, 5B, 5C, and 6 provides 3 such distinct thermal conductivity detectors. For example, a first thermal conductivity detector is formed using flow paths 1 and 2; a second thermal conductivity detector is formed using flow paths 3 and 4; and a third thermal conductivity detector is formed using flow paths 5 and 6. In applications that can use a common reference, the embodiment described with respect to FIGS. 5A, 5B, 5C, and 6 provides 5 distinct thermal conductivity detectors. For example, a first thermal conductivity detector is formed using flow paths 1 and 2; a second thermal conductivity detector is formed using flow paths 1 and 3; a third thermal conductivity detector is formed using flow paths 1 and 4; a fourth thermal conductivity is formed using flow paths 1 and 5; and a fifth thermal conductivity detector is formed using flow paths 1 and 6. Combinations of the above configurations are also possible. For example, four thermal conductivity detectors can be formed as follows. A first thermal conductivity detector is formed using flow paths 1 and 2; a second thermal conductivity is formed using flow paths 1 and 5; a third thermal conductivity is formed using flow paths 1 and 6; and a fourth thermal conductivity is formed using flow paths 3 and 4. Thus, embodiments described herein provide a significant number of configurations in a compact structure that can be easily mounted within an oven of a gas chromatograph. It is believed that embodiments described herein will provide a more compact structure and that the temperature of the thermistor locations will be more evenly distributed, which improves accuracy of the thermal conductivity measurements.

Although the present invention has been described with reference to preferred embodiments, workers skilled in the art will recognize that changes may be made in form and detail without departing from the spirit and scope of the invention.

What is claimed is:

1. A thermal conductivity detector for a gas chromatograph, the thermal conductivity detector comprising:
a circular thermal conductivity detector body having a sidewall and a top surface;
a plurality of gas flow paths formed in the circular thermal conductivity body, each gas flow path comprising a gas inlet disposed on the sidewall and a gas outlet disposed on the sidewall, wherein the inlet and the outlet extend inwardly from the sidewall; and
wherein each gas flow path is in fluidic communication with a thermistor mounting hole, the thermistor mounting hole extending from the top surface of the thermal conductivity detector body.

2. The thermal conductivity detector of claim 1, wherein each thermistor mounting hole is configured to receive a thermistor and position a thermistor element within a flow area of a respective gas flow path.

3. The thermal conductivity detector of claim 1, and further comprising a thermistor mounted in each thermistor mounting hole.

4. The thermal conductivity detector of claim 3, and further comprising a gas fitting mounted to each gas inlet and gas outlet of each gas flow path.

5. The thermal conductivity detector of claim 4, wherein the plurality of gas flow paths includes six gas flow paths.

6. The thermal conductivity detector of claim 5, wherein the six gas flow paths are used to provide three distinct thermal conductivity detectors.

7. The thermal conductivity detector of claim 5, wherein the six gas flow paths are used to provide four distinct thermal conductivity detectors.

8. The thermal conductivity detector of claim 5, wherein the six gas flow paths are used to provide five distinct thermal conductivity detectors.

9. The thermal conductivity detector of claim 1, wherein the thermal conductivity detector body includes a temperature sensor hole configured to house an RTD or thermocouple.

10. The thermal conductivity detector of claim 1, wherein the gas inlet of each gas flow path extends inwardly from the sidewall toward a center of the circular thermal conductivity body.

11. The thermal conductivity detector of claim 10, wherein the gas outlet of each gas flow path extends inwardly from the sidewall toward a center of the circular thermal conductivity body.

12. The thermal conductivity detector of claim 11, wherein each thermistor mounting hole is positioned such that it intersects with each respective gas inlet and gas outlet.

13. The thermal conductivity detector of claim 11, wherein each thermistor mounting hole fluidically couples each respective gas inlet to each respective gas outlet.

14. The thermal conductivity detector of claim 1, wherein the plurality of gas flow paths is spaced apart along the sidewall.

15. A process gas chromatograph comprising:
a temperature-controlled oven;
at least one chromatographic column disposed within the temperature-controlled oven and being configured to receive a sample of process gas;
at least one thermal conductivity detector operably coupled to the at least one chromatographic column and disposed within the temperature-controlled oven, the at least one thermal conductivity detector being configured to provide an indication of thermal conductivity of the sample; and
wherein the at least one thermal conductivity detector includes,
a circular thermal conductivity detector body having a sidewall and a top surface,
a plurality of gas flow paths formed in the circular thermal conductivity body, each gas flow path comprising a gas inlet disposed on the sidewall and a gas outlet disposed on the sidewall, wherein the inlet and the outlet extend inwardly from the sidewall, and
wherein each gas flow path is in fluidic communication with a thermistor mounting hole, the thermistor mounting hole extending from the top surface of the thermal conductivity detector body.

16. The process gas chromatograph of claim 15, and further comprising a thermistor mounted in each thermistor mounting hole.

17. The process gas chromatograph of claim 15, and further comprising a gas fitting mounted to each gas inlet and gas outlet of each gas flow path.

18. The process gas chromatograph of claim 15, wherein the plurality of gas flow paths includes six gas flow paths.
